(19) United States
(12) Patent Application Publication
(10) Pub. No.: US 2012/0134012 A1
(43) Pub. Date: May 31, 2012

(54) PERIODICALLY POLED OPTICAL WAVEGUIDE

(75) Inventors: Nicolas GUERIN, San Jose, CA (US); Boris Kharlamov, San Jose, CA (US); Robert Duval, Milpitas, CA (US); Karl Kissa, West Simsbury, CT (US)

(73) Assignee: JDS Uniphase Corporation, Milpitas, CA (US)

(21) Appl. No.: 13/306,635

(22) Filed: Nov. 29, 2011

Related U.S. Application Data
(60) Provisional application No. 61/418,225, filed on Nov. 30, 2010.

(51) Int. Cl. G02F 1/377; G02F 1/365; B29D 11/00; G02B 6/10

(52) U.S. Cl. 359/328; 385/122; 359/326; 264/1.27

(57) ABSTRACT

A periodically poled optical waveguide comprising a nonlinear optical crystalline material is provided having poled optical domains slanted with respect to direction of propagation of light within the waveguide. Light reflected from slanted poled optical domains does not couple efficiently back into the optical waveguide, which facilitates reduction of backreflection towards a semiconductor laser source coupled to the waveguide. Reduction of backreflections facilitates stable operation of the semiconductor laser source. A method of manufacturing of a periodically poled optical waveguide with slanted poled domains is also provided.

### CROSS-REFERENCE TO RELATED APPLICATIONS

The present invention claims priority from U.S. Patent application No. 61/418,225 filed Nov. 30, 2010, which is incorporated herein by reference for all purposes.

### TECHNICAL FIELD

The present invention relates to optical waveguides, and in particular to periodically poled optical waveguides for non-linear optical frequency conversion.

### BACKGROUND OF THE INVENTION

A nonlinear optical phenomenon of optical frequency conversion can be used to provide quasi-monochromatic visible and UV light sources based on inexpensive, efficient, and reliable laser diodes operating in a near infrared wavelength range. In these visible/UV sources, light emitted by a laser diode is directed through a nonlinear optical element, which converts the infrared emission of the laser diode into visible or UV light.

A periodically poled waveguide formed in a nonlinear optical crystal is increasingly used as the nonlinear optical element for frequency conversion. Referring to FIG. 1, a waveguide 10 having a core 15 is formed in a nonlinear optical crystal 11. Periodically disposed areas, or domains 12 of the nonlinear optical crystal 11 are “poled”, that is, a direction of a crystalline structure in these areas is reversed. The direction of the crystalline structure can be reversed, for example, by applying a localized strong electric field to the domains 12. The poling period is selected so as to facilitate phase matching of light at the laser frequency, called fundamental frequency, and light at the converted frequency, called signal frequency or output frequency.

Light at fundamental and converted frequencies can travel large distances in the waveguide while remaining highly concentrated. As a result, the periodically poled waveguide can have high enough conversion efficiency to provide a reasonable (50% or more) conversion even for continuous-wave (cw) infrared light of a moderate optical power, for example about 200 mW. Furthermore, sensitivity to optical misalignment, which has been a major disadvantage of previously used bulk nonlinear optical crystals, is considerably lessened in periodically poled crystalline waveguides.

The excellent light guiding property of periodically poled waveguides, however, is inherently associated with a serious drawback. The periodic poling creates an optical waveguide grating that reflects light at some wavelengths back towards the laser source, creating a guided reflected wave, which destabilizes the laser source. For example, referring to FIG. 2, a typical reflection spectrum of the poled waveguide 10 of FIG. 1 includes peaks at approximately 977, 985, and 989 nm.

Theoretically, poling should not modify the refractive index of the waveguide 10. However, unavoidable crystalline defects and dislocations at boundaries 14 of the poled domains 12 do create some refractive index modulation. Furthermore, periodic poling can corrugate the upper surface of the waveguide 10 as shown in FIG. 3, which is a cross-sectional side view of the waveguide 10 of FIG. 1 taken along lines A-A. The poling-caused corrugation height can reach 10 nanometers at the waveguide depth of 3-4 micrometers. Over a length of the waveguide 10, the refractive index modulation, corrugations, and other periodic perturbations can create a backreflection of up to tens of percent, which is more than sufficient to de-stabilize a reflection-sensitive laser diode.

The problem of backreflection from a periodically poled waveguide into the laser is known. In U.S. Pat. No. 7,492,507 by Gollier, a wavelength conversion device having a reduced backreflection is disclosed. Referring to FIG. 4, a frequency doubled light source 40 includes a laser diode 41, an optical coupler 42, and a poled waveguide 43. The crystallographic axis directions are denoted with arrows within the waveguide 43. In operation, the laser diode 41 emits light 44, which is focused by the optical coupler 42 onto the waveguide 43. The waveguide 43 doubles the optical frequency of the laser light 44 through nonlinear optical effect known as second harmonic generation (SHG), and the emission at the doubled frequency exits the periodically poled waveguide 43 as shown at 45. The waveguide 43 is a poled waveguide comprising domains of randomly varying widths. The domain widths are defined by an ideal poling period λ_{I} plus or minus a disruption value. The waveguide 43 includes “normal” domains 46, “wide” domains 47, and “narrow” domains 48. “Wide” and “narrow” domains 47 and 48 reduce the coherence of reflected light, thus reducing the optical power of the backreflected light.

In U.S. Pat. No. 7,414,778 by Gollier et al., a similar wavelength conversion device is disclosed, wherein the domain period is altered to shift reflection wavelengths away from the laser wavelength, thus reducing the optical power of backreflected light.

In U.S. Pat. No. 7,177,340 by Lang et al., a tunable laser source is described wherein an optical isolator is inserted in front of a periodically poled waveguide to suppress reflections of light from the periodically poled crystal back into the laser.

The prior art approaches to reducing the amount of backreflected light in poled waveguides require either separate optical isolators having a substantial insertion loss, or they require modifying the poling period, which considerably reduces optical conversion efficiency. Introduction of additional optical losses, or reduction of the optical conversion efficiency are undesirable because they lead to a reduction of output optical power and/or a reduction of wall plug efficiency of the prior-art light sources.

It is a goal of the present invention to provide a periodically poled waveguide having a suppressed reflection of light at fundamental frequency, substantially without compromising the optical conversion efficiency.

### SUMMARY OF THE INVENTION

In accordance with the invention, there is provided a periodically poled optical waveguide comprising a nonlinear optical crystalline material, wherein poled domains of the optical waveguide are slanted with respect to an optical axis of the waveguide for reducing backreflection of light propagating therein. In a preferred embodiment, the slant angle is between 5 and 20 degrees. In other words, the angle between the poled domains and the optical axis or direction of propagation of light in the waveguide is away from perpendicular by 5 to 20 degrees. For ease of manufacturing of planar waveguides, it is preferable that the slant direction is in the plane of the waveguide. Light reflected by slanted poled domains does not couple back into the waveguide effectively, and as a result, the total backreflection by the poled domains is considerably reduced.

In accordance with another aspect of the invention, there is further provided a light source comprising a semiconductor laser and the optical waveguide with slanted domains coupled to the semiconductor laser, whereby in operation, an emission frequency of the laser diode is converted by the optical waveguide to an output frequency different from the emission frequency.

In accordance with another aspect of the invention, there is further provided a method of poling an optical waveguide formed on or in an optical crystal, comprising

(a) providing a poling electrode having an array of slanted parallel fingers spaced apart along a first axis;
(b) applying the poling electrode to an outer surface of the optical waveguide; and
(c) energizing the poling electrode to form an array of slanted poled domains in the optical waveguide.

### BRIEF DESCRIPTION OF THE DRAWINGS

Exemplary embodiments will now be described in conjunction with the drawings in which:

FIG. 1 is a top view of a prior-art periodically poled waveguide;

FIG. 2 is a typical reflection spectrum of the waveguide of FIG. 1;

FIG. 3 is a side cross-sectional view of the waveguide of FIG. 1, showing corrugation of an upper surface of the waveguide created in the poling process;

FIG. 4 is a prior-art wavelength conversion device having a reduced backreflection;

FIG. 5A is a top view of a periodically poled waveguide of the invention;

FIG. 5B is a cross-sectional end view of the waveguide of FIG. 5A taken along lines B-B;

FIG. 6A is a top view of a poling apparatus of the invention;

FIG. 6B is a flow chart of a poling method of the invention;

FIG. 7 is a diagram of a light source using the periodically poled waveguide of FIGS. 5A and 5B;

FIG. 8 is a microphotograph of a front side of a poled waveguide prototype;

FIGS. 9A to 9C are results of simulation of light propagation in a waveguide having a non-slanted refractive index step;

FIGS. 10A to 10C are results of simulation of light propagation in a waveguide having a slanted refractive index step;

FIG. 11 is a spectral plot of reflected and transmitted light propagating in a waveguide having non-slanted refractive index steps; and

FIG. 12 is a spectral plot of reflected and transmitted light propagating in a poled waveguide having slanted refractive index steps.

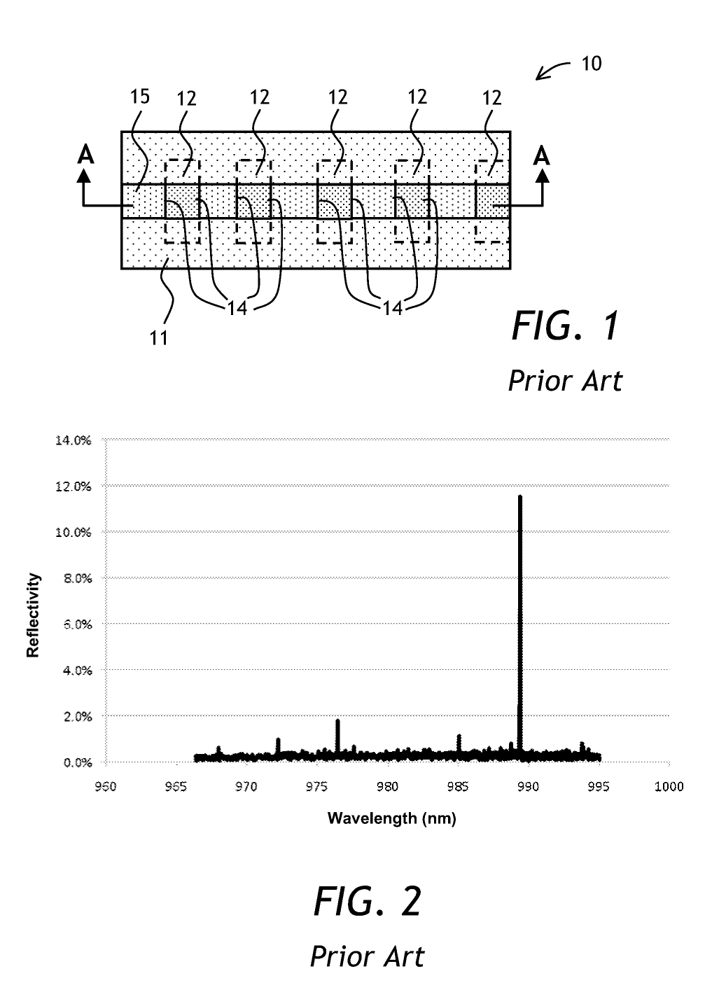

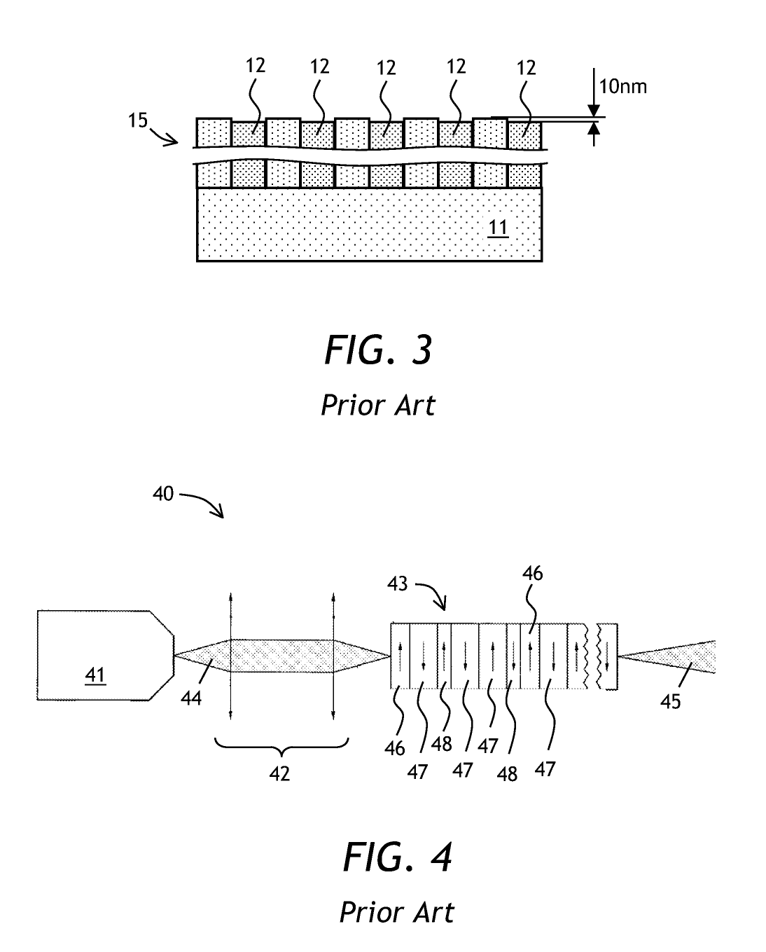

### DETAILED DESCRIPTION OF THE INVENTION

While the present teachings are described in conjunction with various embodiments and examples, it is not intended that the present teachings be limited to such embodiments. On the contrary, the present teachings encompass various alternatives, modifications and equivalents, as will be appreciated by those of skill in the art.

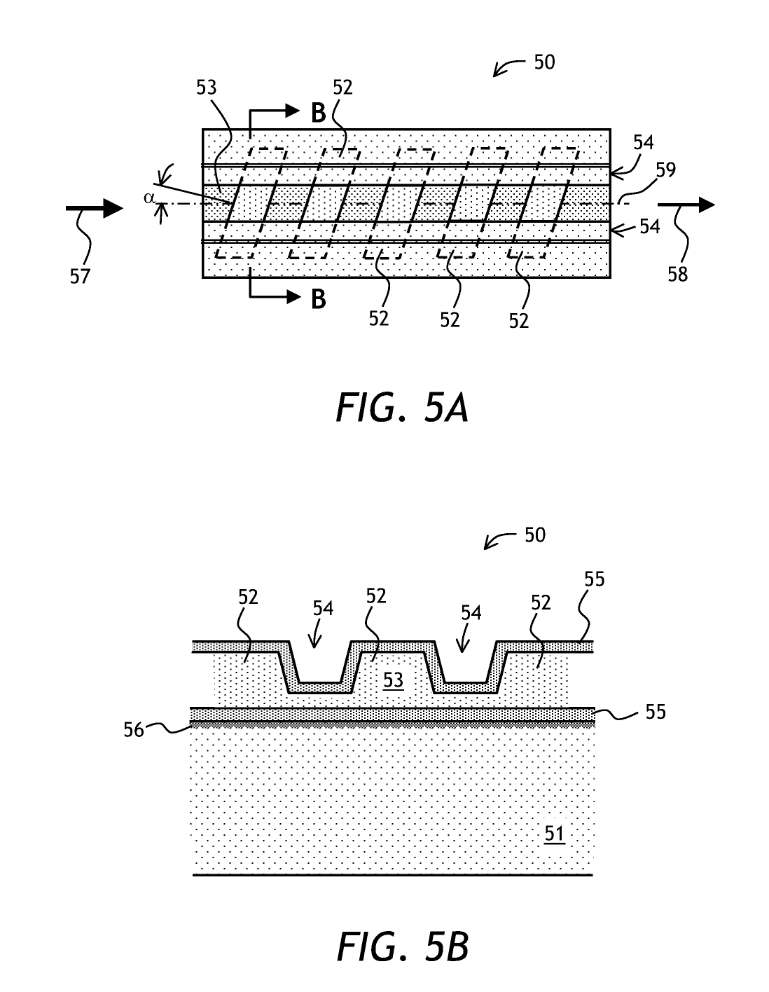

Referring to FIGS. 5A and 5B, a periodically poled planar waveguide 50 ideally comprises a crystalline MgO:LiNbO₃ waveguide formed on a LiNbO₃ substrate 51. The waveguide 50 includes an array of poled domains 52 slanted by a non-zero angle α with respect to an optical axis 59 of the waveguide 50. In other words, the poled domains 52 are away from being perpendicular to the optical axis 59 by the angle α. The slant direction is in the plane of the waveguide 50, that is, the poled domains 52 are tilted about an axis perpendicular to FIG. 5A and the plane of the waveguide 50 by the angle α. Referring to FIG. 5B specifically, the waveguide 50 is a ridge type waveguide including a core 53 surrounded by trenches 54. Two oxide clad layers 55 are disposed on top and bottom of the MgO:LiNbO₃ waveguide 50. The waveguide 50 is fixed to the LiNb substrate 51 by a thin adhesive layer 56.

In operation, light 57 at a fundamental frequency enters the waveguide core 53 as shown in FIG. 5A. Frequency-converted light 58, for example frequency-doubled light, exits the optical waveguide core 53 on the other side of the waveguide 50. Since the domains 52 are slanted by the angle α with respect to the optical axis 59, the reflections at domain borders occur at an angle 2α with respect to the optical axis 59, so the reflected light does not couple back into the waveguide core 53.

The invention can work with different types of waveguides, including ridge waveguides formed on a substrate as shown in FIGS. 5A and 5B, buried waveguides formed in a substrate, non-planar waveguides, non-ridge waveguides, etc. In general, any poled crystalline waveguide used for nonlinear optical frequency conversion can benefit from slanted domains according to the present invention. The nonlinear optical crystalline materials of the waveguide can include LiNb, LiTa, KTP, or any other suitable nonlinear optical materials.

The bigger the slant angle α of the poled domains 52, the better is backreflection suppression, however the frequency conversion efficiency may drop. It has been found that a range of 5 to 20 degrees provides a useful backreflection suppression at a moderate conversion efficiency drop. A preferred range, within which the backreflection is well suppressed while the efficiency of frequency conversion drops negligibly, is between 6 and 12 degrees. The poled domains 52 are typically between 2 and 7 micrometers long. The domain length is measured in the direction of the optical axis 59 of the waveguide 50.

Although the direction of slant of domains 52 in FIG. 5A is in the plane of the waveguide 50, that is, in the plane of FIG. 5A, the invention will also work in cases where the slant direction is perpendicular to the plane of the waveguide 50, or where it forms any other angle with the plane of the waveguide 50. Furthermore, the invention will work with other waveguide types, for example with waveguides formed on or within the crystalline substrate 51. An optical axis of the crystalline substrate 51, not shown, is typically oriented in a pre-defined relationship to the optical axis 53 of the waveguide 50, for example, the optical axis of the crystalline substrate 51 can be parallel to the optical axis 53 of the waveguide 50.

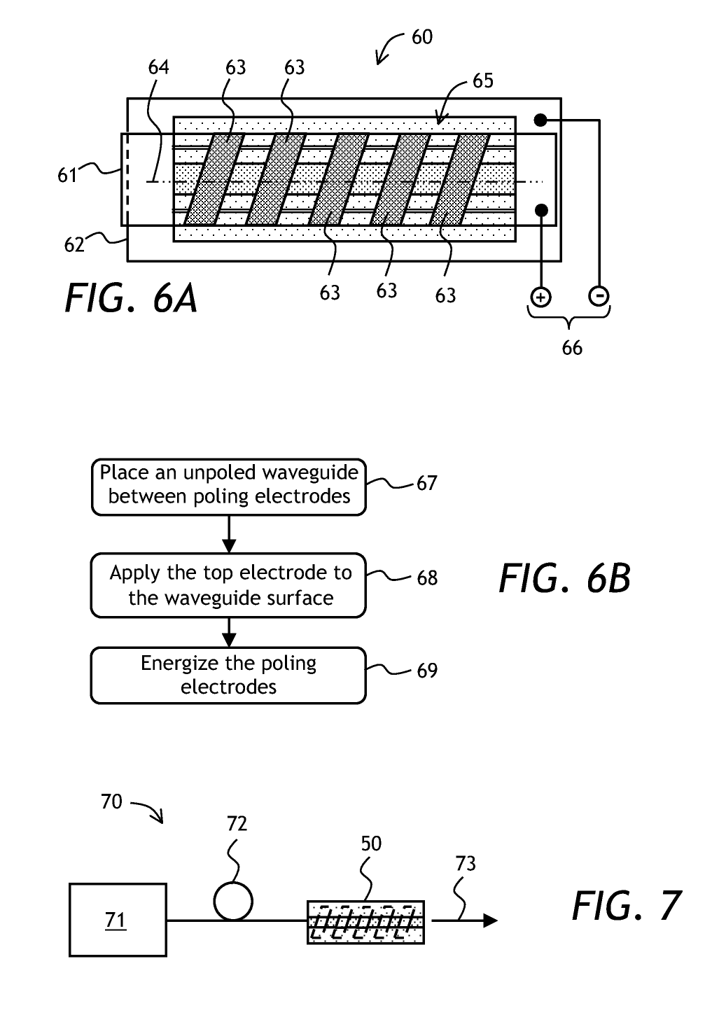

Referring now to FIGS. 6A and 6B, an embodiment of a poling apparatus 60 of the invention includes top and bottom poling electrodes 61 and 62, respectively. The top poling electrode 61 includes an array of slanted parallel fingers 63 spaced apart along an axis 64. To make the poled waveguide 50, an unpoled waveguide 65 is placed between the top and bottom poling electrodes 61 and 62 in a step 67. In a step 68, the top poling electrode 61 is applied to an upper surface 63 of the optical waveguide, so that an angle between the fingers 63 and an optical axis of the optical waveguide is away from perpendicular by 8 to 20 degrees. Then, in a step 69, the poling electrodes 61 and 62 are energized by applying a high voltage 66 therebetween. Care is taken to prevent electrical sparks from forming between the top and bottom poling electrodes 61 and 62, respectively, to avoid damaging the waveguide 65.

Turning to FIG. 7, a light source 70 includes a semiconductor laser 71 and the periodically poled optical waveguide 50 coupled to the semiconductor laser 71 by an optical fiber 72. Due to low backreflection from the periodically poled waveguide 50, an optical isolator needs not be placed between the semiconductor laser 71 and the periodically poled optical waveguide 50. The semiconductor laser 71 is preferably a telecom grade laser diode operating in near-infrared wavelength range suitable for pumping erbium doped optical fibers. Such diode lasers are well developed and are quite reliable.

In the embodiment of FIG. 7, the periodically poled optical waveguide 50 is optimized for second harmonic generation. Frequency doubled output 73 is in visible wavelength range, for example in green-blue range. By way of example, when the laser diode 71 operates at 976 nm, the frequency doubled output 73 is at 488 nm. Of course, other lasing wavelengths can be used. The material, waveguide dimensions, and poling period of the periodically poled waveguide 50 are all selected according to the laser diode and output beam specifications. Such selections are well within the scope of knowledge of a person skilled in the art.

The non-linear frequency conversion can include second-harmonic generation (SHG); third-harmonic generation (THG); and generally any sum/differential frequency generation used in optical parametric oscillators (OPO). By way of another example, a 325 nm UV monochromatic light source can be constructed by coupling a 976 nm infrared semiconductor laser to a THG poled waveguide having slanted domains described above. Although a lens based free-space coupler can be employed to couple emission of the laser 71 to the periodically poled waveguide 50, fiber coupling is preferable because it reduces alignment sensitivity and improves stability and reliability of the light source 70.

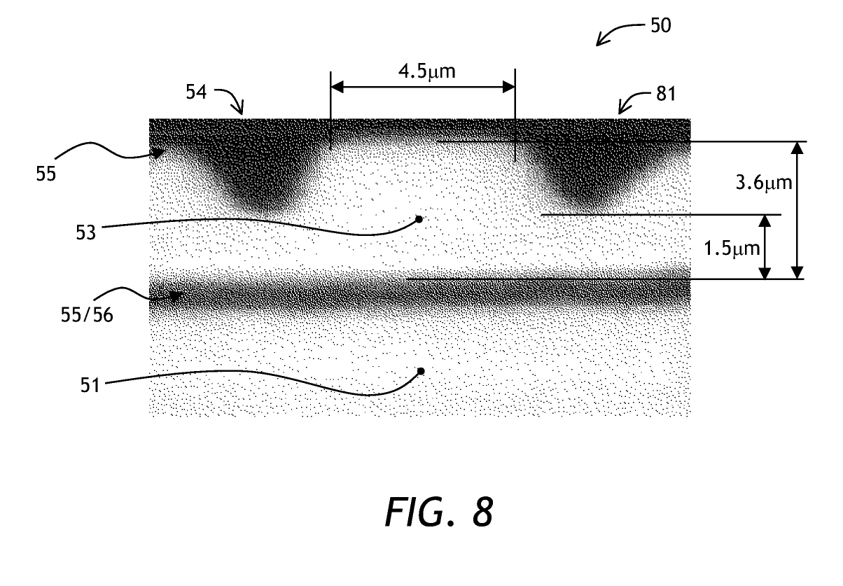

Referring to FIG. 8, a front end of a prototype of the periodically poled waveguide 50 for second harmonic generation from 976 nm to 488 nm has been photographed through a microscope. The waveguide core 53 is 4.5 micrometers wide. Trenches 81 are 2.1 microns deep. The periodically poled waveguide 50 is about 3.6 microns thick and 4.5 microns wide. The waveguide 50 is passivated with the oxide layers 55 on both sides. The epoxy layer 56 coalesces with the bottom oxide layer 55 in FIG. 8 because of limited resolution of FIG. 8. The epoxy layer 56 fixes the waveguide 50 to the substrate 51.

The optical performance of the periodically poled waveguide 50 has been verified using two-dimensional Finite Difference Time Domain (FDTD) optical simulations. For comparison purposes, the optical simulations were performed for both a prior-art periodically poled waveguide having non-slanted poled domains and for a similar periodically poled waveguide having slanted poled domains. The simulated waveguides included a single refractive index step of a magnitude of 0.5, representing the poled domains in the waveguides. For non-slanted domains waveguide, the index step was perpendicular to the waveguide. For slanted domains waveguide, the index step was slanted by 8 degrees. Both simulated waveguides were 4.5 micrometers wide and had a refractive index of 2.14 at the wavelength of 976 nm. The cladding refractive index was taken to be 1.0.

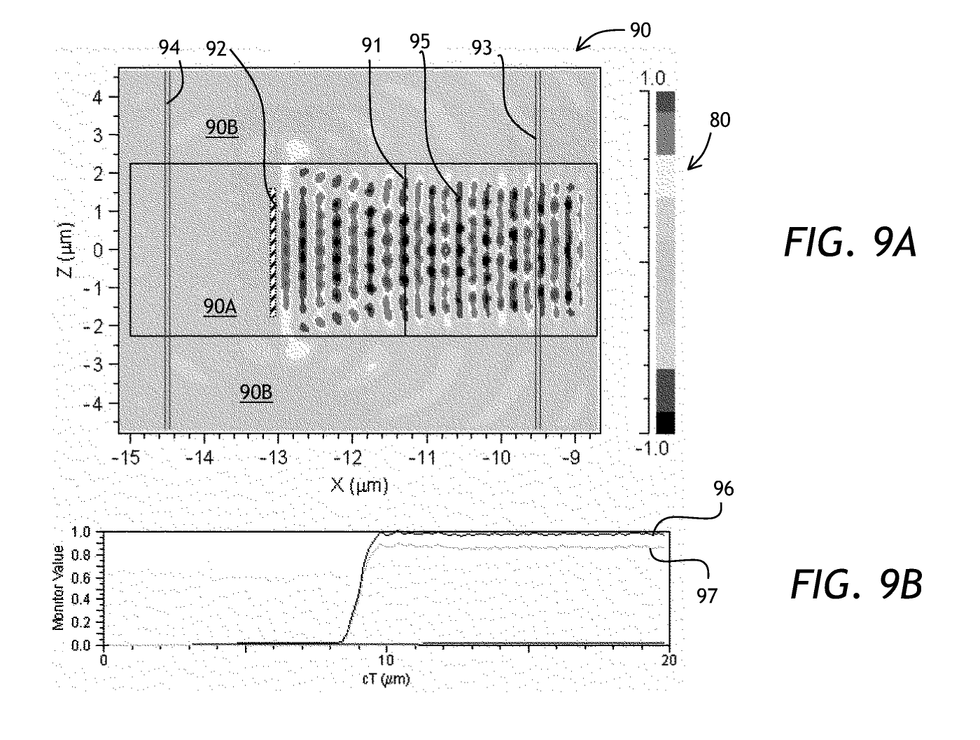

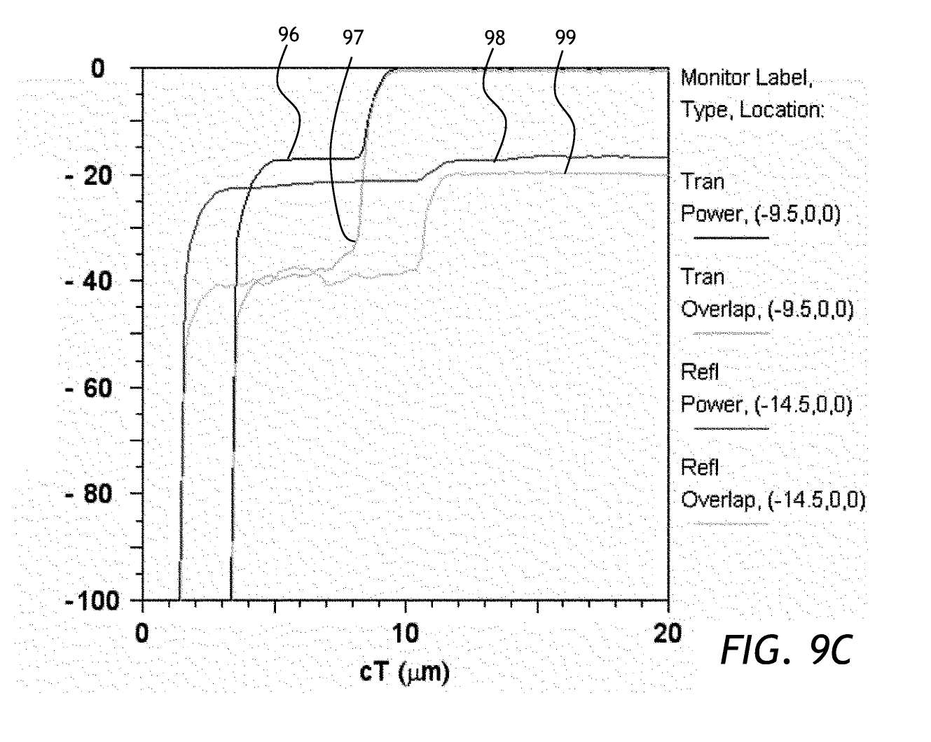

The non-slanted index step simulations will be described first. Referring to FIG. 9A, a waveguide 90 has a core 90A and a cladding 90B. The waveguide core 90A has an index step 91 (of the magnitude 0.5 as noted above) at an X-coordinate of approximately −11.3 micrometers. A reverse refractive index step of 0.5 in magnitude has also been added to the waveguide core 90A at X=−8.7 micrometers (not shown in FIG. 9A) in the waveguide 90 of FIG. 9A. The simulation included one light source 92 and “transmission” and “reflection” monitors 93 and 94 disposed at X=−9.5 micrometers and −14.5 micrometers, respectively. To simplify the simulation, the simulated light source 92 is disposed within the waveguide core 90A. The light source 92 emits a planar wave propagating left to right, towards the index step 91. The wave ridges and valleys are shown at 95. A grayshades scale bar 80 represents a magnitude of the y-component of the electric field, E_{y}, of the wave ridges and valleys 95.

Turning to FIG. 9B, a time dependence of optical power detected by the transmission monitor 94 is shown. In FIG. 9B, the optical power is plotted in linear units. It is normalized to the power of the light source 92. The horizontal scale is in “cT” units, that is, time since turning “on” the light source 92 multiplied by speed of light in vacuum. For example, “10 micrometers” corresponds to the time it takes light to travel 10 micrometers in vacuum. The transmitted wave begins to arrive at the transmission monitor 93 disposed at −9.5 micrometers at cT=8.5 micrometers. Solid and grey lines 96 and 97 denote a total transmitted optical power level and a guided transmitted optical power level, respectively. The guided transmitted power 97 is obtained by calculating an overlap integral of the transmitted electric field E_{y} and a guided propagation mode of the waveguide 90.

Referring now to FIG. 9C, a time dependence of optical power detected by the transmission and reflection monitors 93 and 94, respectively, is shown on a common logarithmic graph in dB units. As in FIG. 9B, the solid and the grey lines 96 and 97 denote a total transmitted optical power level and a guided transmitted optical power level, respectively. Solid and grey lines 98 and 99 denote a total reflected power and a guided reflected power, respectively. The guided reflected power 99 is obtained by calculating an overlap integral of the reflected electric field E_{y} and a reverse guided propagation mode of the waveguide 90. The kinks in the transmitted and reflected power levels 96 to 99 at cT of less than 8 microns are artifacts of the simulation. At cT of between 4 and 8 microns, the total and guided transmitted power levels 96 and 97 are approximately −18 dB and −40 dB, respectively. At cT of between 4 and 9 microns, the total and guided reflected power levels 98 and 99 are approximately −22 dB and −41 dB, respectively. These power levels represent floor noise levels of the numerical simulation. At cT of approximately 8.5 micrometers, the total and guided transmitted power levels 96 and 97 go to the level of 0 dB and approximately −1 dB, respectively, corresponding to the linear power levels of 1.0 and 0.8 in FIG. 9B. At cT of approximately 11.5 micrometers the total and guided reflected power levels 98 and 99 go to the level of −18 dB and −22 dB, respectively. These values correlate well with magnitude of Fresnel reflection from the refractive interface 91.

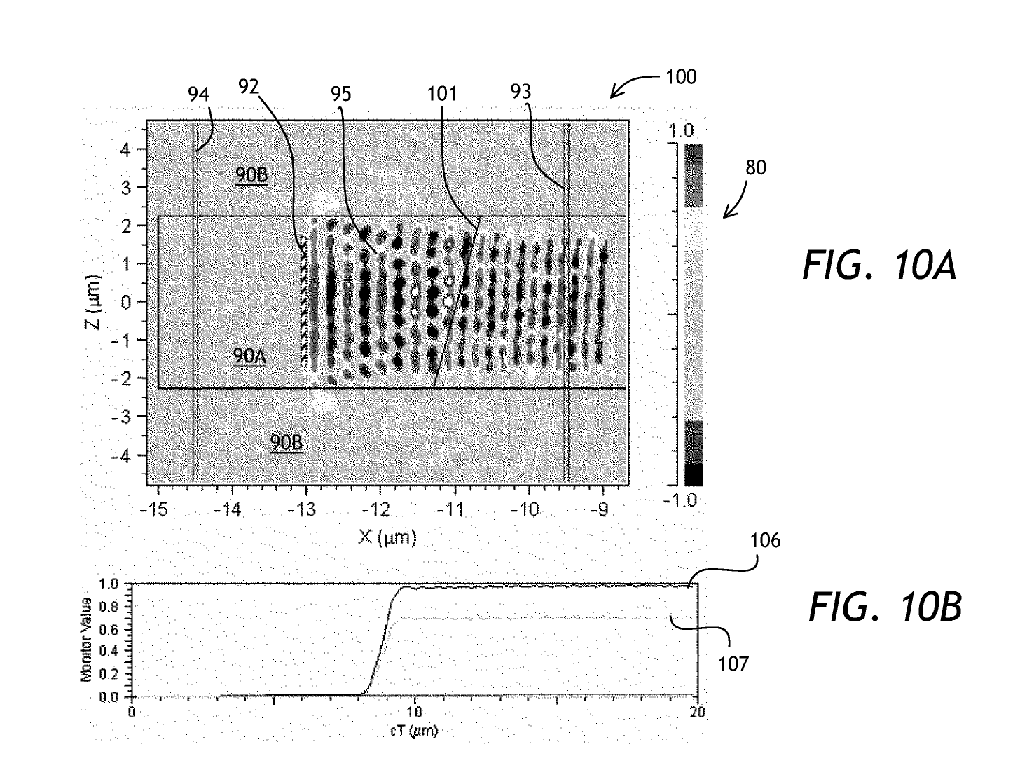

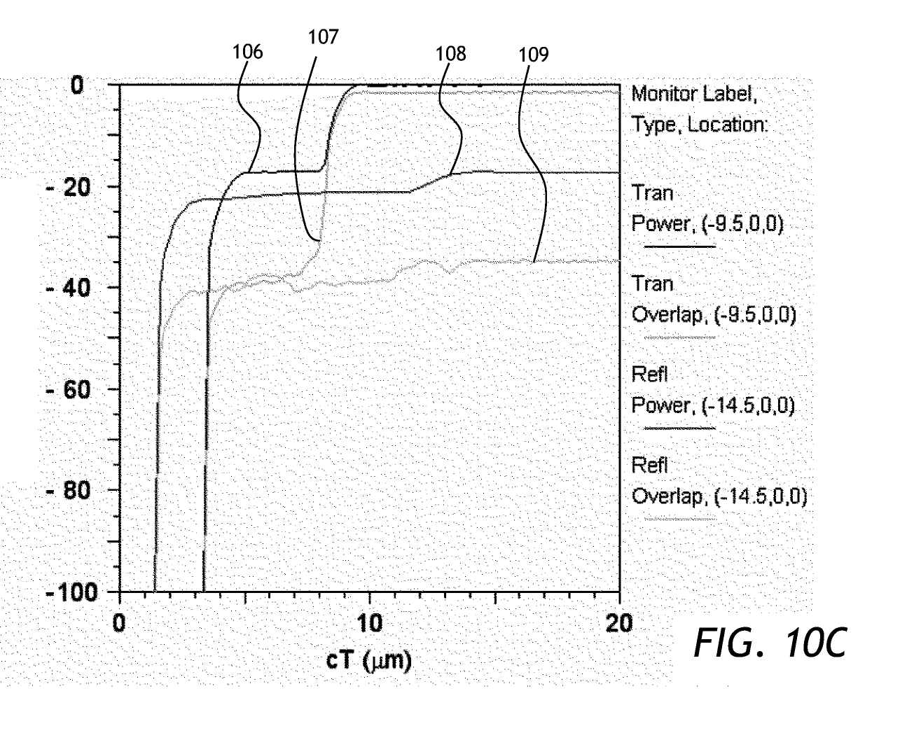

In FIGS. 10A to 10C, the slanted index step simulation results are presented. Referring specifically to FIG. 10A, a waveguide 100 is shown having the core 90A, in which an index step 101 is slanted at 8 degrees with respect to light propagation direction. A reverse slanted refractive index step of 0.5 in magnitude (not shown in FIG. 10A) has also been added to the waveguide core 90A at X=−8.7 micrometers in the waveguide 100 of FIG. 10A. The rest of the simulation set-up is identical to that of FIG. 9A.

Turning to FIG. 10B, solid and grey lines 106 and 107 denote a total transmitted optical power and a guided transmitted optical power, respectively, in the waveguide 100 having the slanted index step 101. The guided transmitted power 107 is obtained by calculating an overlap integral of the transmitted electric field E_{y} and a guided propagation mode of the waveguide 100. It is lower than the guided transmitted power 97 in FIG. 9B because the tilted index step 101 induces a slight angular misalignment of the propagating electromagnetic wave and the waveguide 100.

Referring now to FIG. 10C, a time dependence of optical power detected by the transmission and reflection monitors 94 and 95, respectively, is shown on a common logarithmic graph in dB units. Solid and grey lines 106 and 107 denote a total transmitted optical power and a guided transmitted optical power, respectively, in the waveguide 100 having the slanted index step 101. Solid and grey lines 108 and 109 denote a total reflected power and a guided reflected power, respectively, of a light wave reflected from the tilted refractive index step 101 of the waveguide 100. Again, the guided reflected power 109 is obtained by calculating an overlap integral of the reflected electric field E_{y} and a reverse guided propagation mode of the waveguide 100. At cT of between 4 and 9 microns, the optical power levels 106 to 109 are almost identical to the corresponding optical power levels 96 to 99 of FIG. 9C. At cT of approximately 8.5 micrometers, the total and guided transmitted power levels 106 and 107 of FIG. 10C go to the level of 0 dB and −1.5 dB, respectively, corresponding to the linear power levels of 1.0 and 0.7 in FIG. 9B. At cT of approximately 11.5 micrometers the total and guided reflected power levels 108 and 109 go to the level of −17.7 dB and −37 dB, respectively. Note that the corresponding guided reflected optical power level goes to −22 dB for the waveguide 90 having a straight index step 91.

The guided reflected optical power 109 is about 15 dB lower than the guided reflected optical power 99 in FIG. 9C. Therefore, tilting the refractive index step 101 by 8 degrees results in 15 dB drop in the reflected guided optical power. Accordingly, the simulations of FIGS. 9A-9C and 10A-10C indicate that tilting poled domains in the waveguide 50 results in a backreflection suppression of the order of 15 dB.

Similar calculations have been performed at the slant angles α0 of the refractive index step 101 between 4 and 25 degrees. It has been determined that the guided backreflection is effectively suppressed at the slant angles α of at least 5 degrees. A drop in nonlinear conversion efficiency will depend on the slant angle α of the domains 52. Generally, a larger slant angle α will decrease the conversion efficiency, so a tradeoff slant angle α needs to be found. It has been estimated that at slant angle α of over 20 degrees, the optical conversion efficiency for SHG drops by over 25%, while at slant angle α of 8 degrees it drops only by 10% or less. The conversion efficiency drop is moderate because in the present invention, the periodicity of poling of the optical waveguide 50 is preserved. Generally, the slant angle α of between 5 to 20 degrees has been found to be workable, and the range of between 6 and 12 degrees is preferable. Accordingly, the slant angle of the parallel fingers 63 of FIG. 6A of the electrode 61 is selected to be preferably between 5 to 20 degrees and most preferably between 6 and 12 degrees.

A simulation of a steady-state optical power distribution in the waveguides 90 and 100 of FIGS. 9A and 10A has been performed. The structure used in the simulations is identical to that of FIGS. 9A and 10A. A Fast Fourier Transform (FFT) was performed on the optical field time domain data as observed at the power monitors 93 and 94. The wavelength of the light source was varied from 0.8 to 1.2 micrometers.

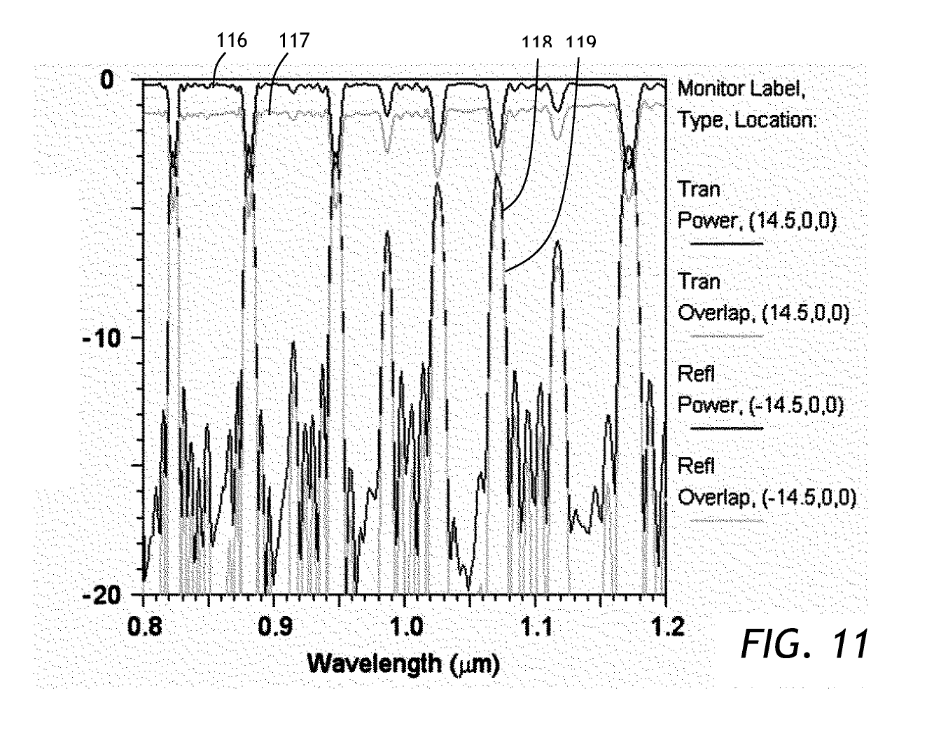

Turning to FIG. 11, logarithmic spectral plots of simulated reflected and transmitted optical power are presented for the case of the straight waveguide domain. Lines 116, 117, 118, and 119 represent wavelength dependence of total transmitted optical power, guided transmitted optical power, total reflected optical power, and guided reflected optical power, respectively, normalized to the input power value. The peak structure seen in all four spectra 116, 117, 118, and 119 results from etalon-like effect observed between two straight refractive index steps. Peaks of the spectrum 119 of the guided reflected optical power are −3 to −6 dB down the input optical power value.

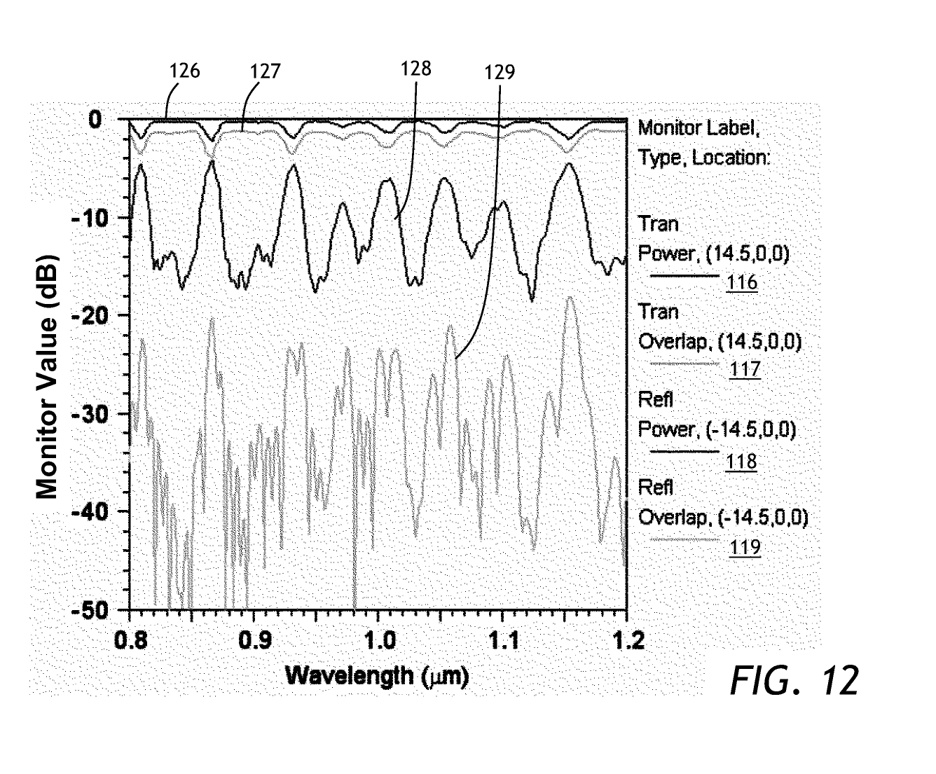

Referring now to FIG. 12, logarithmic spectral plots of simulated reflected and transmitted optical power are presented for the case of the slanted waveguide domain. Lines 126, 127, 128, and 129 represent wavelength dependence of total transmitted optical power, guided transmitted optical power, total reflected optical power, and guided reflected optical power, respectively, normalized to the input power value. One can see that peaks of the spectrum 129 of the guided reflected optical power are −19 to −22 dB down the input optical power value. Therefore, the 8-degree slanted domain reflects about 16 dB less light that is guided back into the waveguide 100.

Referring back to FIG. 7, reduction of light reflected back into the laser diode 71 by 15-16 dB considerably improves stability of the laser diode 71, thus improving the power stability of the output optical signal 73 of the light source 70.

The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A periodically poled optical waveguide comprising a nonlinear optical crystalline material, wherein poled domains of the optical waveguide are slanted with respect to an optical axis of the waveguide, for reducing backreflection of light propagating therein.

2. The optical waveguide of claim 1, wherein an angle between the poled domains and the optical axis is away from perpendicular by 5 to 20 degrees.

3. The optical waveguide of claim 2, wherein the angle between the poled domains and the optical axis is away from perpendicular by 6 to 12 degrees.

4. The optical waveguide of claim 1, wherein the optical waveguide is a planar waveguide, and a direction of the slant is in the plane of the waveguide.

5. The optical waveguide of claim 1, wherein the poled domains are between 2 micrometers and 7 micrometers long.

6. The optical waveguide of claim 1, wherein the nonlinear optical crystalline material is selected from the group consisting of MgO:LiNbO₃, LiNbO₃, LiTaO₃, and KTP.

7. The optical waveguide of claim 1, wherein the optical waveguide is disposed on or within a crystalline substrate having an optical axis parallel to the optical axis of the optical waveguide.

8. The optical waveguide of claim 1 of a ridge waveguide type.

9. A light source comprising a semiconductor laser and the optical waveguide of claim 1 coupled thereto, whereby in operation, an emission frequency of the semiconductor laser is converted by the optical waveguide to an output frequency different from the emission frequency.

10. The light source of claim 9, wherein the output frequency is twice the laser emission frequency.

11. The light source of claim 9, further comprising a length of optical fiber for coupling the semiconductor laser to the optical waveguide.

12. A method of poling an optical waveguide formed on or in an optical crystal, comprising
(a) providing a poling electrode having an array of slanted parallel fingers spaced apart along a first axis;
(b) applying the poling electrode to an outer surface of the optical waveguide; and
(c) energizing the poling electrode to form an array of slanted poled domains in the optical waveguide.

13. The method of claim 12, wherein in step (b), an angle between the fingers and an optical axis of the optical waveguide is away from perpendicular by 5 to 20 degrees.

14. The method of claim 13, wherein in step (b), the angle is between 6 and 12 degrees.
